(19) United States
(12) Patent Application Publication
(10) Pub. No.: US 2006/0268669 A1
(43) Pub. Date: Nov. 30, 2006

(54) Optical pickup unit and information recording/reproducing apparatus

(76) Inventors: Nobuaki Kaji, Yokohama-shi (JP); Sumitaka Maruyama, Yokohama-shi (JP); Kazuo Watabe, Yokohama-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/442,997

(22) Filed: May 31, 2006

(30) Foreign Application Priority Data
May 31, 2005 (JP) 2005-160476

(51) Int. Cl. G11B 7/00; G02B 27/40

(52) U.S. Cl. 369/44.11; 250/201.5

(57) ABSTRACT

An embodiment of the invention is useful for providing an optical pickup unit, which condenses light with different wavelengths at different positions and focal distances, and exactly detects a focus error signal when receiving the reflected light with different wavelengths from two or more kinds of recording medium, in the state that the focal distance of a condensing means is the same as the distance from the recording surface of a recording medium to the condensing means, by dividing light with different wavelengths emitted from light sources and reflected by a recording medium into a predetermined number by a diffraction element, and condensing at a position of a predetermined distance in a predetermined direction.

### CROSS-REFERENCE TO RELATED APPLICATIONS

This application is based upon and claims the benefit of priority from Japanese Patent Application No. 2005-160476, filed May 31, 2005, the entire contents of which are incorporated herein by reference.

### BACKGROUND

1. Field

One embodiment of the invention relates to an information recording/reproducing apparatus (optical disc apparatus) for recording, reproducing and erasing information on/from a recordable, reproduceable and erasable optical disc by using a laser beam, and an optical pickup unit used in the optical disc apparatus.

2. Description of the Related Art

An optical disc is widely used as a recording medium suitable for recording, reproducing and erasing (recording repeatedly) information. Various optical discs of different standards have been proposed and are actually used. By the recording capacity, these optical discs are classified into CD and DVD. By use (data-recording systems), the discs are sorted into a read-only type containing prerecorded information (ROM), a write once type capable of recording information only once (-R), and a rewritable type (recordable/reproduceable or rewritable type) capable of recording and erasing information repeatedly (RAM or RW).

As the standard and purpose of an optical disc have been diversified, an optical disc recording/reproducing apparatus is required to be capable of recording information on an optical disc of two or more standards, reproducing prerecorded information, and erasing recorded information. Besides, it is demanded as an essential condition of an optical disc recording/reproducing apparatus to be capable of detecting a standard of an optical disc set in the apparatus, even if it is difficult to record and erase information.

Therefore, an optical pickup incorporated in an optical disc information recording/reproducing apparatus is required at least to be capable of capturing a reflected light from tracks or a string of record marks peculiar to an optical disc and controlling the tracks and focus of an objective lens (optical pickup), regardless of the standards (types) of an optical disc.

In the circumstances, Japanese Patent

Application Publication (KOKAI) No. 2000-76689 proposes an optical pickup unit, which is provided with two hologram elements for light beams with different wavelengths from two light sources, so that a focus error signal detecting beam is positioned on a line dividing a common light-receiving element.

However, in the optical pickup unit of the above Publication, a diffraction grating corresponding to each wavelength is necessary, and the number of diffraction elements corresponding to the number of the wavelengths of optical beams from the light sources are required. This increases the cost.

A diffraction angle of ±1^{st} diffracted light of a reflected light from a recording medium is different according to the kind of that recording media (the wavelength of the light to use).

Therefore, a focus error signal cannot be exactly detected in an optical pickup unit which receives reflected light with different wavelengths from two or more kinds of recording medium.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram showing an example of an optical disc apparatus including an optical pickup head (PUH) in accordance with an embodiment of the invention;

FIG. 2A is an exemplary diagram showing an example of a diffraction pattern of a diffraction element incorporated in an optical pickup head shown in FIG. 1;

FIGS. 2B and 2C are exemplary diagrams each showing an example of a detecting area pattern of a detecting element incorporated in an optical pickup head shown in FIG. 1;

FIGS. 3A and 3B are exemplary diagrams each showing a relation between a light-receiving plane of a photodetector and a wavelength of an optical beam diffracted by a diffraction element, in the diffraction element and photodetector shown in FIG. 1;

FIGS. 4A and 4B are exemplary diagrams each showing an example of a detecting area pattern of a detecting element incorporated in an optical pickup head shown in FIG. 1;

FIG. 5A is an exemplary diagram showing an example of a diffraction pattern of a diffraction element incorporated in an optical pickup head shown in FIG. 1;

FIGS. 5B and 5C are exemplary diagrams each showing an example of a detecting area pattern of a detecting element incorporated in an optical pickup head shown in FIG. 1;

FIG. 6A is an exemplary diagram showing an example of a diffraction pattern of a diffraction element incorporated in an optical pickup head shown in FIG. 1;

FIGS. 6B and 6C are exemplary diagrams each showing an example of a detecting area pattern of a detecting element incorporated in an optical pickup head shown in FIG. 1;

FIG. 7 is an exemplary diagram showing the influence of light leaking from a non-reproducing layer, when an optical disc has two or more recording layers; and

FIG. 8 is an exemplary diagram showing an embodiment which decreases the influence of leakage light explained in FIG. 7, by using the diffraction element shown in FIG. 6A and the photodetector shown in FIGS. 6B and 6C.

### DETAILED DESCRIPTION

Various embodiments according to the invention will be described hereinafter with reference to the accompanying drawings. In general, according to one embodiment of the invention, an optical pickup unit, which condenses light with different wavelengths at different positions and focal distances, and exactly detects a focus error signal and a track cross signal when receiving the reflected light with different wavelengths from two or more kinds of recording medium, in the state that the focal distance of a condensing means is the same as the distance from the recording surface of a recording medium to the condensing means, by dividing light with different wavelengths emitted from light sources and reflected by a recording medium into a predetermined number by a diffraction element, and condensing at a position of a predetermined distance in a predetermined direction.

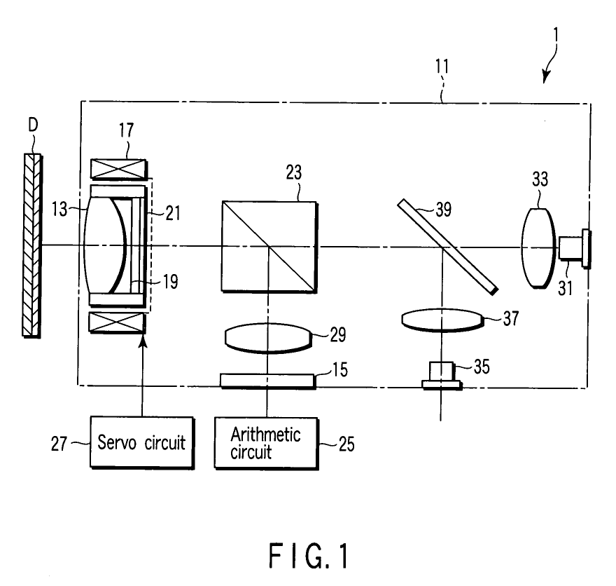

According to an embodiment, FIG. 1 shows an example of an optical disc apparatus including an optical pickup according to an embodiment of the present invention.

An information recording/reproducing apparatus or an optical disc apparatus 1 shown in FIG. 1 can record or reproduce back information on/from an optical disc D by condensing a laser beam emitted from an optical pickup (PUH actuator) 11 on the information recording layer of a recording medium, that is, the optical disc D.

The optical disc D is held on a not-shown turntable of a not-shown disc motor, and rotated at a predetermined speed when the disc motor is rotated at a predetermined speed.

The PUH (optical pickup) 11 is moved at a predetermined speed by a not-shown pickup sending motor in the radial direction of the optical disc D, when recording, reproducing or erasing information.

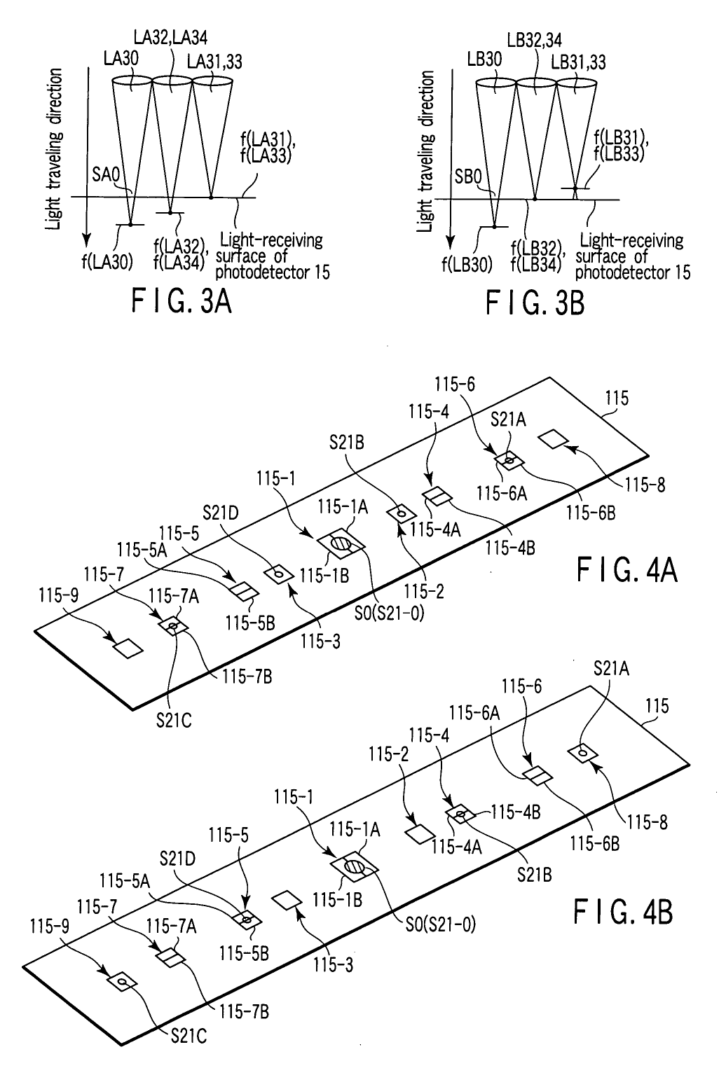

The PUH 11 is provided with an objective lens 13 which condenses optical beams (laser beams) with predetermined wavelengths from first and second laser diodes explained later, on the recording surface of the optical disc D, and a photodetector (PD) 15 which receives reflected laser beams reflected on the recording surface of the optical disc D and captured by the objective lens 13, and outputs electric current (or voltage) corresponding to the intensity of the reflected laser beams. As described in detail later with reference to FIGS. 3A and 3B, the photodetector 15 is positioned to obtain optical spots with predetermined sizes (cross section) (to specify the on-focus state), in the on-focus state that the spot diameters of optical beams (laser beams) with predetermined wavelengths from the first and second laser diodes are minimum on the recording surface of an optical disc.

The objective lens 13 is optionally moved by a focusing/tracking coil 17, in the direction orthogonal to the surface including the recording surface of the optical disc D, that is, a focusing direction, and in the direction parallel to the surface including the recording surface of the optical disc D, that is, the radial direction or the track direction of the optical disc D. The objective lens 13 is made of plastic, and the numerical aperture NA is 0.65, for example.

Between the objective lens 13 and PD (photodetector) 15, a λ/4 plate 19 is provided to change the direction of the plane of polarization of a laser beam guided from a laser diode described later to the recording surface of the disc D and the direction of the plane of polarization of the reflected laser beam reflected on the recording surface of the optical disc D by 90°. The λ/4 plate 19 may be provided integrally with the objective lens 13 and the focusing/tracking coil 17, as shown in FIG. 1. The side of the λ/4 plate 19 opposite to the objective lens 13 (the side to enter the optical beam from the laser diode) is formed integrally with a diffraction element (wavefront splitting element, HOE or hologram optical element) 21 which gives a predetermined characteristic to a wavefront of a reflected laser beam reflected on the optical disc D. The characteristic given to a reflected laser beam by HOE (diffraction element) 21 includes diffraction to several directions and splitting of wavefront.

Between the λ/4 plate 19 (and HOE 21) and PD (photodetector) 15, a polarization beam splitter 23 is provided to transmit the light from the laser diode to the optical disc D (objective lens 13), and reflect a reflected laser beam reflected on the recording surface of the optical disc D toward the light-receiving plane of the PD 15.

The signal detected by the photodetector (PD) 15 is applied to a signal processor (arithmetic circuit) 25 provided in a later stage, and processed to be usable as a data signal used for reproducing information recorded in the optical disc D. A part of the signal output from the arithmetic circuit 25 is supplied to a servo circuit (lens position controller) 27, and used as a control signal to set the objective lens 13 (PUH 11) to a predetermined position with respect to the recording surface of the optical disc D. Namely, the servo circuit 27 supplies the focusing/tracking coil 17 with a focusing control signal to move the objective lens 13 in the focusing direction, so that the optical spot condensed on the recording surface of the optical disc D by the objective lens 13 becomes minimum on the recording layer of the recording surface of the optical disc D. The servo circuit 27 also supplies the focusing/tracking coil 17 with a tracking control signal to move the objective lens 13 in the track direction, so that the center of the optical spot coincides with the center of a string of record marks recorded on the optical disc D or previously formed tracks (guide grooves).

Between the polarization beam splitter 21 and PD 15, an imaging lens 29 is provided to condense the reflected laser beam reflected by the polarization beam splitter 23 on the light-receiving plane of the PD 15.

In the direction of applying a laser beam to the objective lens 13 through the polarization beam splitter 23, there are provided a first semiconductor laser element 31 to emit a laser beam with a first wavelength, a first collimator lens 33 to collimate an optical beam emitted from the first semiconductor laser element 31, a second semiconductor laser element 35 to emit a laser beam with a second wavelength, and a second collimator lens 37 to collimate an optical beam emitted from the second semiconductor laser element 35. The first and second semiconductor laser elements 31 and 35 are placed at an angle of substantially 90°, and the optical paths are stacked by a dichroic mirror 39, so that the axial lines (the direction of main light ray) of emitted laser beams (optical beams) toward the objective lens 13 are substantially the same.

The first laser element 31 is positioned in the direction of passing the emitted light (laser beam) through the wavelength selecting film (selecting reflection plane) of the dichroic mirror 39, for example. Therefore, the second laser element 35 is positioned, so that the emitted light is reflected on the wavelength selecting film of the dichroic mirror 39, and stacked on the axial line of the light directing from the first laser element to the objective lens 13. The wavelength of the laser beam emitted from the first laser element 31 is approximately 405 nm (400 to 410 nm). The wavelength of the laser beam emitted from the second laser element 35 is approximately 650 nm (640 to 670 nm). Of course, it is permitted to set the wavelength of the laser beam emitted from the first laser element 31 to approximately 405 nm (400 to 410 nm) or 650 nm (640 to 670), and the wavelength of the laser beam emitted from the second laser element 35 to approximately 780 nm (770 to 790 nm) or 780 nm (770 to 790 nm).

In the PUH 11 (optical disc unit 1) shown in FIG. 1, a linearly polarized laser beam with a wavelength of 405 nm from the first laser element 31 is collimated by the collimator lens 33, transmitted through the dichroic mirror 39, passed through the polarization beam splitter 23, and applied to the diffraction element 21. The diffraction element 21 is made of anisotropic optical crystal, for example, and generates a diffracted light for a linearly polarized light in a certain direction, but does not generate a diffracted light for a linearly polarized light rotated 90° in the polarization direction. A light emitted from the first semiconductor laser 31 and applied to the diffraction element 21 is polarized in the direction of not generating a diffracted light in the diffraction optical element 21, and applied to the λ/4 plate (¼ wavelength plate) 19 through the diffraction element 21 without being diffracted.

The plane of polarization of the laser beam (with a wavelength of 405 nm) applied to the λ/4 plate 19 is converted to a circularly polarized light, and condensed on the recording layer of the optical disc D by the objective lens 13. As an optical disc D, an optical disc of (next generation) DVD (hereinafter called HD DVD) standard which permits higher density recording with compared with a current DVD standard optical disc can be used. Of course, it is possible to use various kinds (standards) of known discs, such as, a DVD-RAM disc capable of recording and erasing information with a current DVD standard, DVD-RW, DVD-R disc capable of writing new information, and a DVD-ROM disc containing prerecorded information.

A reflected laser beam (of light with a wavelength of 405 nm) reflected on the recording layer of the optical disc D is collimated by the objective lens 13, passed again through the λ/4 plate 19, converted to a linearly polarized light inclined 90° in the polarization direction (rotated) with respect to the polarization direction of the polarized light of the laser beam moving from the laser element 31 to the optical disc D, transmitted through the diffraction element 21, and returned to the polarization beam splitter 23.

The reflected laser beam (of light with a wavelength of 405 nm) returned to the polarization beam splitter 23 is reflected by the polarization beam splitter, and condensed on the light-receiving plane of the photodetector 15 in a predetermined number of division and in a predetermined condensing pattern.

The linearly polarized laser beam with a wavelength of 650 nm from the second laser element 35 is collimated by the collimator lens 37, reflected on the mirror surface of the dichroic mirror 39, guided to the polarization beam splitter 23, transmitted through the polarization beam splitter 23, and applied to the diffraction element 21. The direction of the plane of polarization of the laser beam with the second wavelength applied to the diffraction element 21 is defined the same as the laser beam with the first wavelength, transmitted through the diffraction element 21 without being diffracted, and applied to the λ/4 plate 19.

The plane of polarization of the laser beam (of light with a wavelength of 650 nm) applied to the λ/4 plate 19 is converted to a circularly polarized light, and condensed on the recording layer of the optical disc D by the objective lens 13.

The reflected laser beam (of light with a wavelength of 650 nm) reflected on the recording layer of the optical disc D is collimated by the objective lens 13, passed again through the λ/4 plate 19, converted to a linearly polarized light inclined 90° in the polarization direction (rotated) with respect to the polarization direction of the polarized light of the laser beam traveling from the laser element 35 to the optical disc D, transmitted through the diffraction element 21, and returned to the polarization beam splitter 23.

The reflected laser beam (of light with a wavelength of 650 nm) returned to the polarization beam splitter 23 is reflected by the polarization beam splitter 23, and condensed on the light-receiving plane of the photodetector 15 in a predetermined number of division and in a predetermined condensing pattern.

In the optical pickup (optical disc apparatus) shown in FIG. 1, as already explained, the reflected laser beam is reflected by the polarization beam splitter, and given a predetermined diffraction characteristic by the diffraction element 21 to be able to reach a respective detecting area, according to the number of detecting (light-receiving) areas of the photodetector 15 and the positions of the detecting areas.

The reflected laser beam divided into several divisions and given a predetermined diffraction characteristic by the diffraction element 21 is condensed by the imaging lens 29, in respective light-receiving areas of the PD 15 previously arranged and given predetermined sizes.

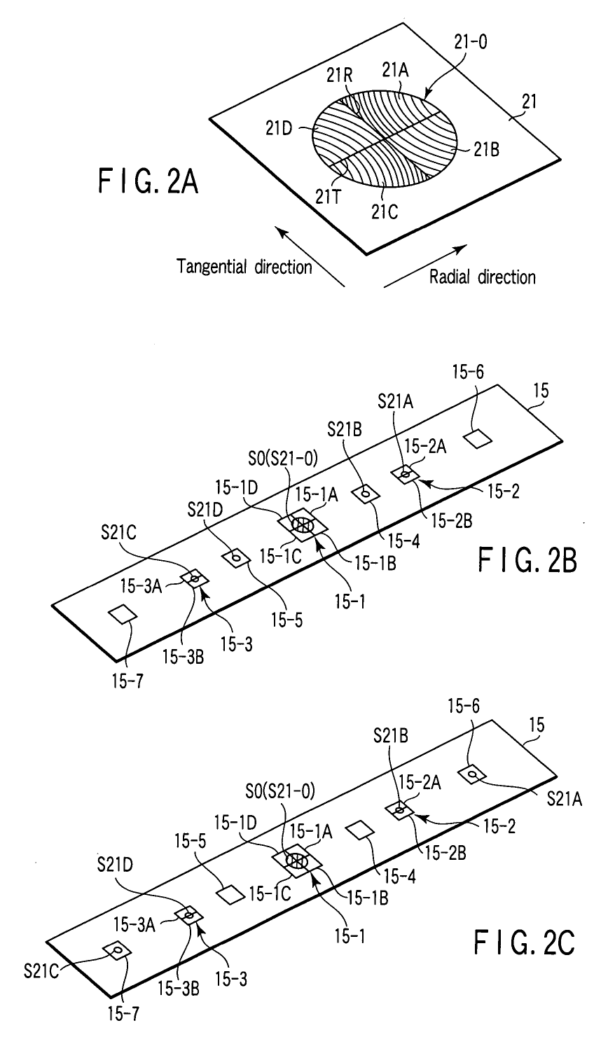

The diffraction element 21 has a grating area (dividing pattern) 21-0 defined to have the same position and size as those of a 0^{th} light (non-diffracted light) of the reflected laser beam from the optical disc D, as shown in FIG. 2A.

The grating area (dividing pattern) 21-0 is divided into four areas, 21A-21D, by a first boundary line 21R passing through substantially the center of the radial direction and a second boundary line 21T (tangential direction) crossing at substantially the center of the boundary line 21R. Each of the 4-divided areas has a curved surface pattern of grating grooves given curves with uneven intervals along the boundary line 21T extending direction, from the position where the boundary line 21R crosses the boundary line 21T. Namely, each grating area of the diffraction element 21 has a lens effect of changing curvature (power) while moving from the center to the peripheral edge portion along the boundary 21T.

Each grating area of the diffraction element 21 is a blazed diffraction element, for example. A laser beam transmitting through each area is separated mainly to non-diffracted light (0^{th} light) and +1^{st} diffracted light.

As shown in FIGS. 2B and 2C, the light-receiving plane of the photodetector (PD) 15 has first to fourth 4-segment detecting areas 15-1A to 15-1D, each divided into four segments by the lines corresponding to the boundary lines 21R and 21T of the diffraction element 21. The light-receiving plane further has first to seventh detecting cells 15-1 to 15-7. The first detecting cell 15-1 is so positioned that a non-diffracted light beam (0^{th}-order light beam) may pass the center of the cell 15-1 (FIG. 2B) after passing the intersection of the lines 21R and 21T. The second detecting cell 15-2 is divided into two areas of 15-2A and 15-2B, and the third detecting cell 15-3 into two areas of 15-3A and 15-3B. The fourth to seventh cells 15-4 to 15-7 are provided at predetermined positions. In the first detecting cell 15-1, the 0^{th}-order light beam passing through the diffraction pattern 21-0 is focused. In the second to seventh cells 15-2 to 15-7, the 1st-order light beams S21 to S21 diffracted by the areas 21A to 21D of the diffraction element 21 are focused. The positional relation between the 1st-order diffracted light beams S21A to S21D focused in the cells and the wavelength of laser beam will be described later in detail.

FIG. 3A shows the relation between the diffracted light and non-diffracted light (0^{th} light) of the first laser beam and the light-receiving plane of a photodetector to detect them, in the on-focus state that the spot diameter of a first laser beam with a wavelength of 405 nm is minimum on the recording surface of an optical disc.

Similarly, FIG. 3B shows the relation between the diffracted light and non-diffracted light (0^{th} light) of the second laser beam and the light-receiving plane of a photodetector to detect them, in the on-focus state that the spot diameter of a second laser beam with a wavelength of 650 nm is minimum on the recording surface of an optical disc.

The diffraction pattern of the areas 21A and 21C of the diffraction element 21 shown in FIG. 2A is a curved surface with uneven intervals, and defined as shown in FIG. 3A, so that a 1^{st} diffracted light, LA31 or LA33 of a first laser beam LA with a wavelength of 405 nm diffracted by the areas 21A and 21C of the diffraction element 21 is focused on the light-receiving plane of the photodetector 15, in the on-focus state that the spot diameter of a first laser beam with a wavelength of 405 nm is minimum on the recording surface of an optical disc. A 0^{th} light (non-diffracted light) LA30 not diffracted by the diffraction pattern of the diffraction element 21 is defined to obtain a spot of a predetermined size (cross section) at a position not focused on the light-receiving plane of the photodetector 15.

The diffraction pattern of the areas 21B and 21D of the diffraction element 21 is a curved surface with uneven intervals different from the diffraction pattern of the areas 21A and 21C, and defined as shown in FIG. 3B, so that a 1^{st} diffracted light, LB32 or LB34 of a second laser beam LB with a wavelength of 650 nm diffracted by the areas 21B and 21D of the diffraction element 21 is focused on the light-receiving plane of the photodetector 15, in the on-focus state that the spot diameter of a second laser beam with a wavelength of 650 nm is minimum on the recording surface of an optical disc. A 0^{th} light (non-diffracted light) LB30 not diffracted by the diffraction pattern of the diffraction element 21 is defined, so that a spot of a predetermined size (cross section) is obtained at a position not focused on the light-receiving plane of the photodetector 15.

In other words, as shown in FIG. 3A, a focal position f (LA30) of the 0^{th} light (non-diffracted light) of the laser beam with a wavelength of 405 nm is in the rear of the light-receiving plane of the photodetector 15 (before focusing on the light-receiving plane). The curvature and pitch of grating grooves of the diffraction patterns 21A and 21C are optimized, so that the focal position f (LA31) of the 1^{st} diffracted light LA31 and focal position f (LA33) of the 1^{st} diffracted light LA33 of the laser beam with a wavelength of 405 nm diffracted by the areas 21A and 21C of the diffraction element 21 coincide on the light-receiving plane of the photodetector 15.

Similarly, as shown in FIG. 3B, a focal position f (LB30) of the 0^{th} light (non-diffracted light) of the laser beam with a wavelength of 650 nm is in the rear of the light-receiving plane of the photodetector 15 (before focusing on the light-receiving plane). The curvature and pitch of grating grooves of the diffraction patterns 21B and 21D are optimized, so that the focal position f (LB32) of the 1^{st} diffracted light LB32 and focal position f (LB34) of the 1^{st} diffracted light LB34 of the laser beam with a wavelength of 650 nm diffracted by the areas 21B and 21D of the diffraction element 21 coincide on the light-receiving plane of the photodetector 15.

Since the areas 21A and 21C of the diffraction element 21 are given a pattern able to condense a laser beam with a wavelength of 405 nm on the light-receiving plane, and the diffraction angle for a laser beam with a wavelength of 650 nm is larger than the diffraction angle for a laser beam with a wavelength of 405 nm.

So the focal position with a wavelength of 650 nm is in front of the light-receiving plane of the photodetector 15 (after focusing on the light-receiving plane).

Namely, in the on-focus state that the spot diameter of a second laser beam with a wavelength of 650 nm is minimum on the recording surface of an optical disc, as shown in FIG. 3B, the focal positions of the 1^{st} diffracted light LB31 and LB33 of the second laser beam LB with a wavelength of 650 nm diffracted by the areas 21A and 21C of the diffraction element 21 are in front of the light-receiving plane of the photodetector 15.

Similarly, the areas 21B and 21D of the diffraction element 21 are given a pattern able to condense a laser beam with a wavelength of 650 nm on the light-receiving plane, in the on-focus state, and the diffraction angle for a laser beam with a wavelength of 405 nm is smaller than the diffraction angle for a laser beam with a wavelength of 650 nm.

So the focal position with a wavelength of 405 nm is in the rear of the light-receiving plane of the photodetector 15 (before focusing on the light-receiving plane).

Namely, in the on-focus state that the spot diameter of a first laser beam with a wavelength of 405 nm is minimum on the recording surface of an optical disc, as shown in FIG. 3A, the focal positions of the 1^{st} diffracted light LA32 and LA34 of the first laser beam LA with a wavelength of 405 nm diffracted by the areas 21B and 21D of the diffraction element 21 are in the rear of the light-receiving plane of the photodetector 15.

Refer again to FIGS. 2A to 2C.

FIG. 2B shows the positions of the diffracted light and non-diffracted light of the first laser beam with a wavelength of 405 nm on the light-receiving surface of the photodetector 15, in the on-focus state that the spot diameter of a first laser beam with a wavelength of 405 nm is minimum on the recording surface of an optical disc.

When the laser beam LA from the first laser element with a wavelength of 405 nm is reflected on the recording surface of the optical disc D, with respect to the PD 15 given the detecting areas arranged as shown in FIGS. 2B and 2C, by using the diffraction element 21 given the diffraction pattern (divided areas) shown in FIG. 2A, a non-diffracted light (0^{th} light) of the reflected laser beam passing through the areas 21A to 21D of the diffraction element 21 is condensed at substantially the center of the 4-divided first detecting cell 15-1 of the photodetector 15, in the state that the spot diameter of a first laser beam with a wavelength of 405 nm is minimum on the recording surface of an optical disc.

The size of the optical spot S0 (S21-0) condensed in the first detecting cell 15-1 is a predetermined size in the on-focus state, as explained as SA0 in FIG. 3A.

The light with a wavelength of 405 nm diffracted by the area 21A of the diffraction element 21 is condensed on the line dividing the two detecting areas 15-2A and 15-2B of the second detecting cell 15-2 of the photodetector 15, as an optical spot S21A with a size of 1/m (m=integer) compared with the size of the optical spot S0 condensed in the first detecting cell 15-1. The size difference between the spots S0 and S21A is attained by placing the photodetector 15 at the position where the non-diffracted light becomes the spot S0 with a predetermined size in the on-focus state of the objective lens 13, and displacing the focal points of non-diffracted light and diffracted light to the optical axis direction by making the gratings of the diffraction element 21 a curved surface pattern with uneven intervals, as already explained.

The light with a wavelength of 405 nm diffracted by the area 21B of the diffraction element 21 is focused as a spot S21B at a predetermined position of the fourth detecting cell 15-4 of the photodetector 15.

The light with a wavelength of 405 nm diffracted by the area 21C of the diffraction element 21 is condensed on the line dividing the two detecting areas 15-3A and 15-3B of the third detecting cell 15-3 of the photodetector 15, as an optical spot S21C with a size of 1/m (m=integer) compared with the size of the optical spot S0 condensed in the first detecting cell 15-1. The size difference between the spots S0 and S21C is attained by placing the photodetector 15 at the position where the non-diffracted light becomes the spot S0 with a predetermined size in the on-focus state of the objective lens 13, and displacing the focal points of non-diffracted light and diffracted light to the optical axis direction by making the gratings of the diffraction element 21 a curved surface pattern with uneven intervals, as already explained.

The light with a wavelength of 405 nm diffracted by the area 21D of the diffraction element 21 is focused as a spot S21D at a predetermined position of the fifth detecting cell 15-5 of the photodetector 15.

As shown in FIGS. 3A and 3B, the light diffracted by the areas 21A and 21C of the diffraction element 21 are focused on the light-receiving element 15 in the on-focus that the spot diameter of a first laser beam with a wavelength of 405 nm is minimum on the recording surface of an optical disc. Therefore, a focus error signal (FES) is obtained by calculating the output of a cell indicated as an output I (cell No.) of each detecting cell by the following equation, like a known double knife edge method, by using the spots S21A and S21C condensed on the division line in each of the second detecting cell 15-2 and third detecting cell 15-3.
FES=I(15-2A)−I(15-2B)−I(15-3A)+I(15-3B) (1)

FIG. 2C shows the positions of the diffracted light and non-diffracted light of the second laser beam with a wavelength of 650 nm on the light-receiving surface of the photodetector 15, in the on-focus state that the spot diameter of a second laser beam with a wavelength of 650 nm is minimum on the recording surface of an optical disc.

When the laser beam from the second laser element with a wavelength of 650 nm is reflected on the recording surface of the optical disc D, a non-diffracted light (0^{th} light) of the reflected laser beam passing through the areas 21A to 21D of the diffraction element 21 is condensed at substantially the center of the 4-divided first detecting cell 15-1 of the photodetector 15 in the on-focus state of the objective lens 13.

The size of the optical spot S0 (S21-0) condensed in the first detecting cell 15-1 is a predetermined size in the on-focus state, as explained as SB0 in FIG. 3B.

The light with a wavelength of 650 nm diffracted by the area 21B of the diffraction element 21 is focused on the line dividing the two detecting areas 15-2A and 15-2B of the second detecting cell 15-2 of the photodetector 15, as an optical spot S21B. Likewise, the light diffracted by the area 21D of the diffraction element 21 is focused on the line dividing the two detecting areas 15-3A and 15-3B of the third detecting cell 15-3 of the photodetector 15, as an optical spot S21D.

The laser beam with a wavelength of 650 nm diffracted by the area 21B of the diffraction element 21 is focused as a spot 21A at a predetermined position of the sixth detecting cell 15-6 of the photodetector 15, as shown in FIG. 2C. Similarly, the laser beam with a wavelength of 650 nm diffracted by the area 21D of the diffraction element 21 is focused as a spot 21C at a predetermined position of the seventh detecting cell 15-7 of the photodetector 15.

In the detecting system explained in FIGS. 2A to 2C, the diffracted light of the laser beams with wavelengths of 405 nm and 650 nm used for detecting a focus error are condensed and detected in the second and third detecting cells 15-2 and 15-3 formed at substantially the same distance from the detecting cell 15-1 to receive a 0^{th} light.

Namely, a focus error can be detected by using the spots S2 and S3 condensed on the line division line in each of the second and third detecting cells 15-2 and 15-3, regardless of the wavelength of laser beam. The S/N can be improved by setting the ratio of light amount of 1^{st} diffracted light to 0^{th} diffracted light small and controlling the light amount of the 1^{st} diffracted light.

A push-pull signal is obtained by the following equation, when the output of each detecting cell is indicated as I (cell No.).
[I(15-1D)+I(15-1C)]−[I(15-1A)+I(15-1B)] (2)

However, a push-pull signal is fluctuated in the radial direction by the shift of the objective lens 13 in the radial direction, even if the pit (record mark) coincides with a light spot. It is known that the degree of the influence of the lens shift is different for a signal obtained from a non-diffracted light and a signal obtained from a diffracted light.

Therefore, assume the output of each detecting cell to be I (cell No.), and compensate as a function of the position r of the laser beam in the radial direction (or, radius) on the recording surface of the optical disc D.
T1=[I(15-1D)+I(15-1C)]−[I(15-1A)+I(15-1B)]
(the same as the equation (2)).
   T2=I(15-4)−I(15-5)+I(15-6)−I(15-7) (3)

When a lens is shifted (the center of objective lens 13 moves from the axial line (main light ray) of the laser beam from the laser element 31 (35) to the objective lens 13 in the radial direction coincides with the center of the objective lens 13), the tracking error signal is influenced by the lens shift.

In this case, assuming a tracking error signal to be t1 (r) and t2 (r) when the lens is not shifted (the axial line (main light ray) of the laser beam from the laser element 31 (35) to the object lens 13 coincides with the center of the object lens 13), and the influence of the tracking error signal by the lens shift to be f1 (r) and f2 (r), respectively, T1 and T2 are modified by
T1=t1(r)+f1(r) (4)
T2=t2(r)+f2(r) (5)

Since t2 (r)=at1 (r), f2(r)=bf1 (r) and a≠b, the tracking error signal (TES) not influenced by the lens shift is obtained by
TES=T1−T2/b (6)

Since “b” depends on the light amount ratio of the non-diffracted light to diffracted light of the diffraction element 21, the pitch of tracks of the optical disc D, the depth of track grooves, the pitch of pits and the depth of pits, an optimum value can be given according to the kind of optical disk D.

Therefore, even if the objective lens 13 is shifted, the tracking error signal (TES) not influenced by the lens shift can be obtained.

Further, when the output of each detecting cell is indicated as I (cell No.), T2 can also be obtained by the following equation, instead of the equation (3).
T2=I(15-3A)+I(15-3B)−I(15-2A)−I(15-2B) (7)

The reproducing signal S to reproduce back the information recorded in the optical disc D is generally obtained by the sum of the output signals from all detecting cells, that is
S=I(15-1D)+I(15-1C)+I(15-1A)+I(15-1B)+I(15-2A)+I(15-2B)+I(15-3A)+I(15-3B)+I(15-4)+I(15-5)+I(15-6)+I(15-7) (8)

However, it is known that when the number of detecting cells to add a signal is simply increased, a noise is increased and the S/N is decreased.

Therefore, in the present invention, the light amount ratio of 1^{st} diffracted light to 0^{th} diffracted light is set small and the light amount of 1^{st} diffracted light is controlled, and the S/N of the reproducing signal S is increased by
S=I(15-1D)+I(15-1C)+I(15-1A)+I(15-1B) (9)

Though not explained in detail, by decreasing the number of detecting cells to add a signal, the number of addition circuits can be decreased, and the cost of PUH (optical pickup) can be decreased.

Namely, it is possible to detect the tracking error signal (TES) by using a phase difference by time by the DPD (Differential Phase Detection) method, as follows.
TES=Phase difference between [I(A)] and [I(B)]
   I(A)=(15-1A)+I(15-1C);
   I(B)=(15-1B)+I(15-1D); (10)

As described above, a diffraction element divides the light beam reflected from an optical disc, while the beam remains in an on-focus state of the objective lens 1. The focus point of either part of the beam, obtained by the dividing means, is aligned on the dividing line of the light-receiving cell (15-2 or 15-3) that generates a focus error signal for light beams of any wavelengths. A focus error signal is therefore generated by double knife-edge method. The detecting (light-receiving) cells of a photodetector for obtaining a focus error signal can be shared in an optical pickup unit using two or more leaser beams with different wavelengths, according to standards/kinds of an optical disc. This decreases the number/area of detecting cells of a photodetector, and provides a pickup head (PUH) with high S/N (signal/noise) and low-cost.

This decreases the number/area of detecting cells of a photodetector, and provides a pickup head (PUH) with high S/N (signal/noise) and low-cost.

By arranging gratings of a diffraction element as a curved surface pattern with uneven intervals, the focal positions of diffracted light and non-diffracted light of a reflected light from an optical disc can be displaced by a predetermined amount in the axial direction, and the influence of a lens shift component included in a tracking error signal can be eliminated.

The detecting areas of the photodetector shown in FIGS. 2B and 2C may be modified as shown in FIGS. 4A and 4B. To discriminate from the example shown in FIGS. 2B and 2C, 100 is added to the reference numerals (in FIGS. 4A and 4B). In this case, it becomes necessary to change the pattern (diffraction amount) of diffraction gratings a little to meet the arrangement of detecting areas of a photodetector, but the difference is very small when indicated diagrammatically, and a drawing of the pattern of diffraction gratins is omitted.

On the light-receiving plane of the photodetector (PD) 115, there are provided a first detecting cell 115-1 positioned at substantially the center, second and third detecting cells 115-2 and 115-3 positioned on both sides (as a pair) at a predetermined distance in the direction orthogonal to the line dividing the first detecting cell 115-1, and fourth and fifth detecting cells 115-4 and 115-5 positioned outside (as a pair) the second and third detecting cells 115-2 and 115-3, as shown in FIGS. 4A and 4B. The first detecting cell 115-1 includes detecting cells 115-1A and 115-1B divided corresponding to the boundary line 21R of the diffraction element 21. The fourth and fifth detecting cells 115-4 and 115-5 include detecting cells 115-4A and 115-4B, and 115-5A and 115-5B, respectively, divided corresponding to the boundary line 21T of the diffraction element 21.

Sixth and seventh detecting cells 115-6 and 115-7 are provided as a pair outside the fourth and fifth detecting cells 115-4 and 115-5. Eighth and ninth detecting cells 115-8 and 115-9 are provided as a pair outside the fourth and fifth detecting cells 115-6 and 115-7. Sixth and seventh detecting cells 115-6 and 115-7 include detecting cells 115-6A and 115-6B, and 115-7A and 115-7B, respectively, divided corresponding to the boundary line 21T of the diffraction element 21.

FIG. 4A shows the positions of the diffracted light and non-diffracted light of the first laser beam on the light-receiving surface of the photodetector 15, in the on-focus state that the spot diameter of a laser beam with a first wavelength of 405 nm is minimum on the recording surface of an optical disc.

When the laser beam from the first leaser element with a wavelength of 405 nm is reflected on the recording surface of the optical disc D with respect to the photodetector 115 given the above-mentioned detecting areas, a non-diffracted light (0^{th} light) of the reflected laser beam passing through the areas 21A to 21D of the diffraction element 21 is condensed as S0 (S21-0) at substantially the center of the first detecting cell 115-1 of the photodetector 115 in the state that the spot diameter of a first laser beam with a wavelength of 405 nm is minimum on the recording surface of an optical disc. The size of the optical spot S0 condensed in the first detecting cell 115-1 is a predetermined size in the on-focus state (as explained as SA0 in FIG. 3A).

The light diffracted by the area 21A of the diffraction element 21 is condensed on the line dividing the two detecting areas 115-6A and 115-6B of the sixth detecting cell 115-6 of the photodetector 115, as an optical spot S21A with a size of 1/m (m=integer) compared with the size of the optical spot S0 (S21-0) condensed in the first detecting cell 115-1, as shown in FIG. 4A. The size difference between the spots S0 and S21A is attained by placing the photodetector 115 at the position where the non-diffracted light becomes the spot S0 with a predetermined size in the on-focus state of the objective lens 13, and arranging the gratings of the diffraction element 21 as a curved surface pattern with uneven intervals, as already explained.

The light diffracted by the area 21B of the diffraction element 21 is focused as a spot S21B at a predetermined position of the second detecting cell 115-2 of the photodetector 15.

The light diffracted by the area 21C of the diffraction element 21 is condensed on the line dividing the two detecting areas 115-7A and 115-7B of the seventh detecting cell 115-7 of the photodetector 115, as an optical spot S21C with a size of 1/m (m=integer) compared with the size of the optical spot S0 condensed in the first detecting cell 115-1, as shown in FIG. 4A. The size difference between the spots S0 and S21C is attained by placing the photodetector 115 at the position where the non-diffracted light becomes the spot S0 with a predetermined size in the on-focus state of the objective lens 13, and arranging the gratings of the diffraction element 21 as a curved surface pattern with uneven intervals, as already explained.

The light diffracted by the area 21D of the diffraction element 21 is focused as S21D at a predetermined position of the third detecting cell 115-3 of the photodetector 115.

FIG. 4B shows the positions of the diffracted light and non-diffracted light of the second laser beam with a wavelength of 650 nm on the light-receiving surface of the photodetector 15, in the on-focus state that the spot diameter of a second laser beam with a wavelength of 650 nm is minimum on the recording surface of an optical disc.

When the laser beam from the second laser element with a wavelength of 650 nm is reflected on the recording surface of the optical disc D, a non-diffracted light (0^{th} light) of the reflected laser beam passing through the areas 21A to 21D of the diffraction element 21 is condensed as S0 (S21-0) at substantially the center of the first detecting cell 15-1 of the photodetector 115, in the on-focus state that the spot diameter of a second laser beam with wavelength of 650 nm is minimum on the recording surface of an optical disc. The size of the optical spot S0 condensed in the first detecting cell 115-1 is a predetermined size in the on-focus state, as explained as SB0 in FIG. 3B.

The light diffracted by the area 21A of the diffraction element 21 is focused as S21A at a predetermined position of the eighth detecting cell 115-8 of the photodetector 115.

The light diffracted by the area 21B of the diffraction element 21 is condensed on the line dividing the two detecting areas 115-4A and 115-4B of the fourth detecting cell 115-4 of the photodetector 115, as an optical spot S21B with a size of 1/m (m=integer) compared with the size of the optical spot S0 condensed in the first detecting cell 115-1, as shown in FIG. 4B.

The size difference between the spots S0 and S21B is attained by placing the photodetector 115 at the position where the non-diffracted light becomes the spot S0 with a predetermined size in the on-focus state of the objective lens 13, and arranging the gratings of the diffraction element 21 as a curved surface pattern with uneven intervals, as already explained.

The light diffracted by the area 21C of the diffraction element 21 is focused as S21C at a predetermined position of the ninth detecting cell 115-9 of the photodetector 115.

The light diffracted by the area 21D of the diffraction element 21 is condensed on the line dividing the two detecting areas 115-5A and 115-5B of the fifth detecting cell 115-5 of the photodetector 115, as an optical spot S21D with a size of 1/m (m=integer) compared with the size of the optical spot S0 condensed in the first detecting cell 115-1, as shown in FIG. 4B. The size difference between the spots S0 and S21D is attained by placing the photodetector 115 at the position where the non-diffracted light becomes the spot S0 with a predetermined size in the on-focus state of the objective lens 13, and arranging the gratings of the diffraction element 21 as a curved surface pattern with uneven intervals, as already explained.

By using the photodetector shown in FIGS. 4A and 4B, assuming an output of each detecting cell to be I (cell No.), a focus error signal (FES) for the first laser beam with a wavelength of 405 nm is obtained by the following equation, like a known double knife edge method.
FES=I(115-6A)−I(115-6B)−I(115-7A)+I(115-7B) (11)

A focus error signal (FES) for the second laser beam with a wavelength of 650 nm is obtained by
FES=I(115-4A)−I(115-4B)−I(115-5A)+I(115-5B) (12)

A push-pull signal is obtained by the following equation, when the output of each detecting cell is indicated as I (cell No.).
I(115-5A)−I(115-5B) (13)

However, a push-pull signal is fluctuated by the lens shift as in the photodetector shown in FIGS. 2B and 2C. Therefore, for the laser beam with a wavelength of 405 nm, assume the output of each detecting cell to be I (cell No.), and compensate as a function of the position r of the laser beam in the radial direction (or, radius) on the recording surface of the optical disc D.
T1=I(115-1A)−I(115-1B) . . . Non-diffracted light (14)
T2=[I(115-6A)+I(115-6B)+I(115-2)]−[I(115-7A)+I(115-7B)+I(115-3)] . . . Diffracted light (15)

In this case, assuming a tracking error signal to be t1 (r) and t2 (r) when the lens is not shifted (the axial line (main light ray) of the laser beam from the laser element 31 (35) to the objective lens 13 coincides with the center of the objective lens 13), and the influence of the tracking error signal by the lens shift to be f1 (r) and f2 (r), respectively, T1 and T2 are modified by
T1=t1(r)+f1(r) (16)
(the same as the equation (4))
   T2=t2(r)+f2(r) (17)
(the same as the equation (5))

Since t2 (r)=at1 (r), f2 (r)=bf1 (r) and a≠b, the tracking error signal (TES) not influenced by the lens shift is obtained by
TES=T1−T2/b (18)
(the same as the equation (6))

Since “b” depends on the light amount ratio of the non-diffracted light to diffracted light of the diffraction element 21, the pitch of tracks of the optical disc D, the depth of track grooves, the pitch of pits and the depth of pits, an optimum value can be given according to the kind of optical disk D.

Therefore, even if the objective lens 13 is shifted, the tracking error signal (TES) not influenced by the lens shift can be obtained.

Further, T2 can also be obtained by the following equation, instead of the equation (15).
T2=[I(115-6A)+I(115-6B)]−[I(115-7A)+I(115-7B)] (19)
or
T2=I(115-2)−I(115-3) (20)

The reproducing signal S from the optical disc D is generally obtained by the sum of the output signals, that is
S=I(115-1A)+I(115-1B)+I(115-2)+I(115-3)+I(115-4A)+I(115-4B)+I(115-5A)+I(115-5B)+I(115-6A)+I(115-6B)+I(115-7A)+I(115-7B)+I(115-8)+I(115-9) (21)

However, when the number of detecting cells to add a signal is simply increased, a noise is increased and the S/N of a recording/reproducing signal of an optical disc is decreased.

Therefore, in the present invention, the light amount ratio of 1^{st} diffracted light to 0^{th} diffracted light is set small and the light amount of 1^{st} diffracted light is controlled, and the reproducing signal S can also be obtained by
S=I(115-1A)+I(115-1B) (22)

The tracking error signal (TES) can also be obtained from a phase difference by time by the DPD (Differential Phase Detection) method, as follows.

TES=Phase difference between

[I(A′)] and [I(B′)]
I(A′)=I(115-6A)+I(115-6B)+I(115-7A)+I(115-7B);
I(B′)=I(115-2)+I(115-3); (23)

As described above, as a focus signal and a tracking signal are obtained by dividing a reflected light from an optical disc by a diffraction element and dividing the light symmetrically to a tangential direction, the number of adders is increased to more than in a signal processing system using the photodetector shown in FIGS. 2B and 2C. But, as light-receiving cells are provided independently for different wavelengths, the diffraction pattern of the areas 21A, 21C, 21B and 21D of the diffraction element 21 and the diffraction angles of diffracted light can be independently determined. Therefore, the distance from the center of the light-receiving cell 115 to accept a non-diffracted light to the farthest light-receiving cell to accept a diffracted light can be set shorter than that in the signal processing system using the photodetector shown in FIGS. 2B and 2C. The surface area of the light-receiving element 15 can be reduced, the mounted optical pickup head can be made compact, and the cost can be decreased.

When using a silicon photodiode with a high light-receiving sensitivity (a current flowing in a photodiode/a light intensity applied to a photodiode) as a light-receiving element, the light-receiving sensitivity of a silicon photodiode shows the characteristic that an output signal from a photodetector is smaller when a wavelength is shorter, in the range lower than a wavelength of 900 nm.

In a DVD (Digital Versatile Disc) using a current laser beam with a wavelength of 650 nm, a reading light intensity applied to the optical disc D is defined to approximately 1 mW on the optical disc. In a next-generation optical disc standard HD DVD (High Definition DVD) using a laser beam with a wavelength of 405 nm, a reading light intensity applied to the optical disc D is defined to approximately 0.5 mW on the optical disc, and an output level of a reproducing signal is lowered.

As a spot diameter of a shorter beam is smaller on the optical disc D, and the intensity must be low in a short wavelength laser beam, to obtain the equivalent light surface density regardless of the wavelength. Therefore, the output level of a reproducing signal is lowered furthermore in a next-generation optical disc standard HD DVD (High Definition DVD) using a laser beam with a wavelength of 405 nm.

The diffraction grating 21 shown in FIG. 2A is given a diffraction pattern to generate mainly non-diffracted light (0^{th} light) and +1^{st} diffracted light. But, it is impossible to diffract all light to non-diffracted or +1^{st} diffracted light, and −1^{st} diffracted light or 2^{nd} or higher order diffracted light appears.

These light not applied to the light-receiving cells of a light-receiving element are not converted to a signal, and become a loss. The amount of light becoming a loss is different according to the groove structure of a diffraction grating, and fluctuated by a wavelength even if the groove structure is the same.

Since the level of an output signal from a photodetector is lower when the wavelength of a laser beam is shorter as explained above, the effective efficiency of a diffraction element (the ratio of the total light amount of non-diffracted light and +1^{st} diffracted light applied to the light-receiving cells in a light-receiving element, to the light amount of reflected light applied to a diffraction grating) is desirably set high for a short wavelength, in order to exactly reproducing the information recorded in an optical disc by reducing the fluctuation caused by the wavelength of a signal level from a photodetector, obtaining a signal with an amplitude higher than a certain level in any wavelength, and performing stable servo control.

In this embodiment, non-diffracted light and +1^{st} diffracted light are applied to the detecting cells of the photodetector 15, and the ratio of incident light amount of non-diffracted light to 1^{st} diffraction light is important. However, if other diffraction light such as −1^{st} diffraction light and +2^{nd} diffraction light are applied to the detecting cells of a photodetector and used as a servo signal or an information reproducing signal, it is of course desirable to design a diffraction element to increase the sum of the light amount of the diffraction light including these orders of diffraction light in a short wavelength.

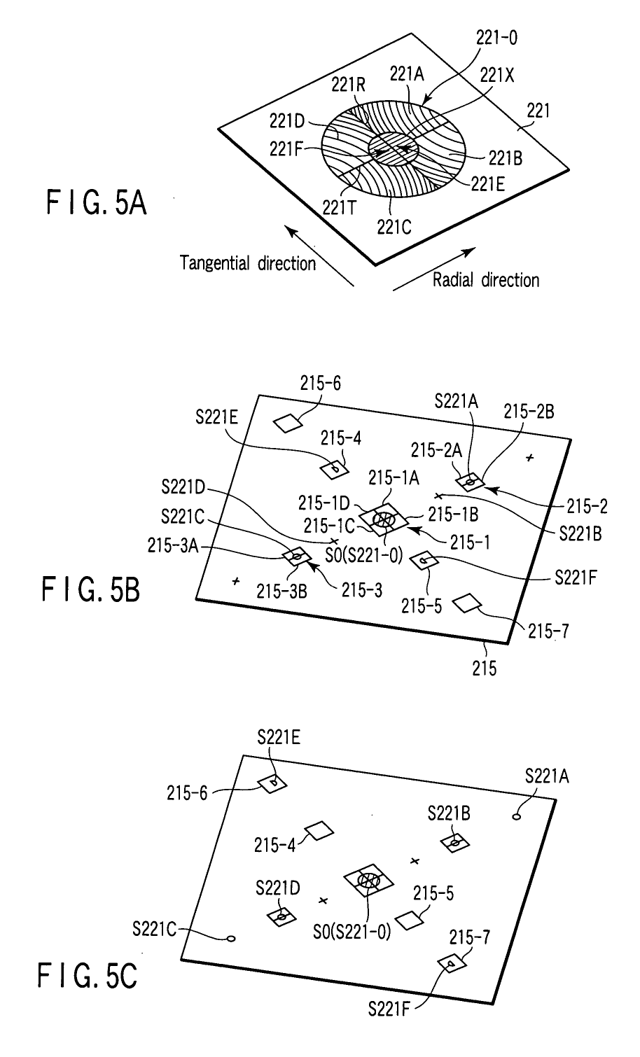

FIGS. 5A to 5C show other detecting cells of the diffraction element and photodetector shown in FIGS. 2A to 2C. To discriminate from the examples shown in FIGS. 2A to 2C and FIGS. 4A and 4B, 200 is added to the reference numerals.

As shown in FIG. 5A, the diffraction element 221 has a grating area (dividing pattern) 221-0 defined to have the same position and size as those of a 0^{th} light (non-diffracted light) of the reflected laser beam from the optical disc D, as in the diffraction element shown in FIG. 2A.

The grating area (dividing pattern) 221-0 is divided into four areas, 221A-221D, by a first boundary line 221R passing through substantially the center of the radial direction and a second boundary line 221T (tangential direction) crossing at substantially the center of the boundary line 221R.

At the center of the 4-divided area, 2-divided areas 221E and 221F with grooves formed in the direction parallel to the boundary line 221R are formed by a division line 221X defined concentrically. Each of the 4-divided areas has a curved surface pattern of grating grooves given curves with uneven intervals along the boundary line 221T extending direction, from the position where the boundary line 221R crosses the boundary line 221T. Each area 221A to 221D of the diffraction elements 221 has a curved surface pattern of grating grooves with uneven intervals to provide a lens effect having power, so that diffracted light is continuously changed in the direction and condensed when a parallel light is applied, for example.

Each grating area of the diffraction element 221 is a blazed diffraction element, for example. A laser beam transmitting through each area is separated mainly to non-diffracted light (0^{th} light) and +1^{st} diffracted light.

As shown in FIGS. 5B and 5C, the light-receiving plane of the photodetector (PD) 215 has 4-divided first to fourth detecting areas 215-1A to 215-1D divided corresponding to the boundary lines 221R and 221T of the diffraction element 21. The light-receiving plane also has a first detecting cell 215-1 formed to have the intersection of the boundary lines 221R and 221T at substantially the center, a second detecting cell 215-2 divided into tow areas of 215-2A and 215-2B, a third detecting cell 215-3 divided into two areas of 215-3A and 125-3B, and fourth to seventh cells 215-4 to 215-7 provided independently in the direction orthogonal to the direction of second and third detecting cells 215-2 and 215-3. The fourth to seventh detecting cells 215-4 to 215-7 correspond to the optical beams divided (diffracted) by the fifth and sixth diffracting areas 221E and 221F divided as concentric circles of the diffraction element 221.

FIG. 5B shows the positions of the diffracted light and non-diffracted light of the first laser beam with a wavelength of 405 nm on the light-receiving surface of the photodetector 215, in the on-focus state that the spot diameter of a first laser beam with a wavelength of 405 nm is minimum on the recording surface of an optical disc.

When the laser beam with a wavelength of 405 nm from the first leaser element is reflected on the recording surface of the optical disc D with respect to the photodetector 215 given the above-mentioned detecting areas, a non-diffracted light (0^{th} light) of the reflected laser beam passing through the areas 221A to 221F of the diffraction element 221 is condensed as S0 (S221-0) at substantially the center of the first detecting cell 215-1 of the photodetector 215 in the state that the spot diameter of the first laser beam with a wavelength of 405 nm is minimum on the recording surface of an optical disc. The size of the optical spot S0 condensed in the first detecting cell 215-1 is a predetermined size in the on-focus state as already explained.

The light with a wavelength of 405 nm diffracted by the area 221A of the diffraction element 221 is condensed on the line dividing the two detecting areas 215-2A and 215-2B of the second detecting cell 215-2 of the photodetector 215, as an optical spot S221A with a size of 1/m (m=integer) compared with the size of the optical spot S0 condensed in the first detecting cell 215-1. The size difference between the spots S0 and S221A is attained by placing the photodetector 215 at the position where the non-diffracted light becomes the spot S0 with a predetermined size in the on-focus state of the objective lens 13, and arranging the gratings of the diffraction element 221 as a curved surface pattern with uneven intervals, as already explained.

The light with a wavelength of 405 nm diffracted by the area 221B of the diffraction element 221 is focused as S221B at a predetermined position in the photodetector 215, though cells are not formed (not detected as a signal in this system).

The light with a wavelength of 405 nm diffracted by the area 221C of the diffraction element 221 is condensed on the line dividing the two detecting areas 215-3A and 215-3B of the third detecting cell 215-3 of the photodetector 215, as an optical spot S221C with a size of 1/m (m=integer) compared with the size of the optical spot S0 condensed in the first detecting cell 215-1. The size difference between the spots S0 and S221C is attained by placing the photodetector 215 at the position where the non-diffracted light becomes the spot S0 with a predetermined size in the on-focus state of the objective lens 13, and arranging the gratings of the diffraction element 221 as a curved surface pattern with uneven intervals, as already explained.

The light with a wavelength of 405 nm diffracted by the area 221D of the diffraction element 221 is focused as S221D at a predetermined position in the photodetector 215, though cells are not formed (not detected as a signal in this system).

The first to fourth areas 221A to 221D of the diffraction element 221 are defined so that the power of the areas 221A and 221C of the diffraction grating 221 becomes the same in symmetry about a point around the position where the boundary lines 221R and 221T cross, and the sizes of two spots S221A and S221C of diffracted light are of course substantially the same.

Namely, in the system shown in FIGS. 5A to 5C, by using the spots S221A and S221C condensed on the line dividing detecting cells in the second and third detecting cells 215-2 and 215-3, an focus error signal (FES) is obtained by the following equation, like a known double knife edge method, assuming an output of each detecting cell to be I (cell No.).
FES=I(215-2A)−I(215-2B)−I(215-4A)+I(215-4B) (24)
(substantially the same as the equation (2))

The spots S221E and S221F of the light diffracted by the areas 221E and 221F of the diffraction element 221 are condensed in the detecting cells 215-4 and 215-5 close to the first detecting cell 215-1.

A tracking error signal is obtained by the following equation based on the compensation push-pull method, assuming an output of each detecting cell to be I (cell No.).
[I(215-1D)+I(215-1C)]−[I(215-1A)+I(215-1B)]+m[I(215-4)−I(215-5)] m is a magnification (25)

When the laser beam with a wavelength of 650 nm from the second leaser element is reflected on the recording surface of the optical disc D, a non-diffracted light (0^{th} light) of the reflected laser beam passing through the areas 221A to 221D of the diffraction element 221 is condensed as S0 (S221-0) at substantially the center of the first detecting cell 215-1 of the photodetector 215, in the state that the spot diameter of a second laser beam with a wavelength of 650 nm is minimum on the recording surface of an optical disc, as shown in FIG. 5B.

FIG. 5C shows the positions of diffracted light and non-diffracted light of the second laser beam with a wavelength of 650 nm on the light-receiving surface of the photodetector 215, in the on-focus state that the spot diameter of a second laser beam with a wavelength of 650 nm is minimum on the recording surface of an optical disc.

The light with a wavelength of 650 nm diffracted by the areas 221A and 221C of the diffraction element 221 is condensed on the line dividing the two detecting areas 215-2A and 215-2B of the second detecting cell 215-3 of the photodetector 215, and on the line dividing the two detecting areas 215-3A and 215-3B of the third detecting cell 215-3, respectively, as shown in FIG. 5C.

The light diffracted by the areas 221A and 221C of the diffraction element 221 is condensed at a predetermined position having no detecting cell in the photodetector 215 (not used in this system).

Namely, a focus error can be detected by using the spots S2 and S3 condensed on the division lines in the second and third detecting cells 215-2 and 215-3, respectively, regardless of the wavelength of a laser beam. The S/N can be increased by controlling the light amount of 1^{st} diffraction light by setting the light amount ratio of 1^{st} diffraction light to 0^{th} diffraction light small.

The spots S221E and S221F of the light with a wavelength of 650 nm diffracted by the areas 221E and 221F of the diffraction element 221 are condensed in the detecting cells 215-6 and 215-7 far from the first detecting cell 215-1.

A tracking error signal is obtained by the following equation based on the compensation push-pull (CPP) method, assuming an output of each detecting cell to be I (cell No.).
[I(215-1D)+I(215-1C)]−[I(215-1A)+I(215-1B)]+n[I(215-6)−I(215-7)] m is a magnification (25′)

Of course, it is possible to detect the tracking error signal (TES) regardless of the wavelength of laser beam, by using a phase difference by time based on the DPD (Differential Phase Detection) method, as follows.

TES=Phase difference between

[I(A″)] and [I(B″)]
I(A″)=(215-1A)+I(215-1C);
I(B″)=(215-1B)+I(215-1D); (26)

The reproducing signal S can be output with the S/N improved by the following equation, based on substantially the same idea as the example shown in FIGS. 2A to 2C or FIGS. 4A and 4B.
S=I(215-1D)+I(215-1C)+I(215-1A)+I(215-1B) (27)

Though not explained in detail, by decreasing the number of detecting cells to add a signal, the number of addition circuits can be decreased, and the cost of PUH (optical pickup) can be decreased.

As above explained, when dividing the

reflected light from an optical disc by using a diffraction element and obtaining a focus error signal by the double knife edge method, detecting (light-receiving) cells of a photodetector for obtaining a focus error signal can be shared in an optical pickup unit using two or more leaser beams with different wavelengths, according to standards/kinds of an optical disc. This decreases the number/area of detecting cells of a photodetector, and provides a pickup head (PUH) with high S/N (signal/noise) and low-cost.

By arranging the gratings of a diffraction element as a curved surface pattern with uneven intervals, the focal positions of diffracted light and non-diffracted light of a reflected light from an optical disc can be displaced by a predetermined amount in the axial direction, and the influence of a lens shift component included in a tracking error signal can be eliminated.

Further, a compensation push-pull signal used for compensation of a tracking error signal can be easily obtained, and a signal processing system can be made simple.

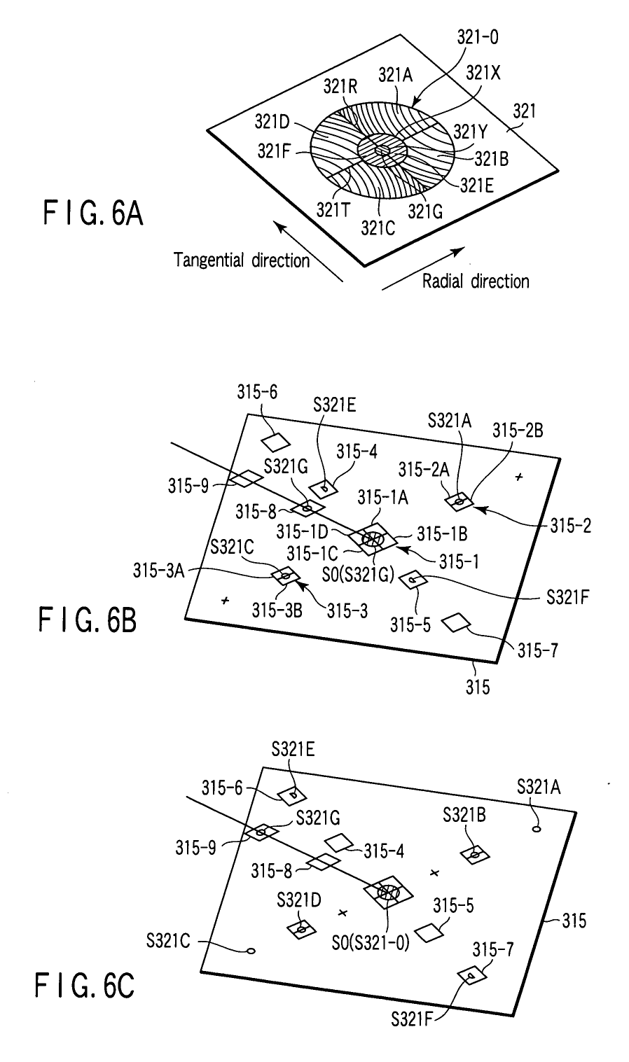

FIGS. 6A to 6C show other detecting cells of the diffraction element and photodetector shown in FIGS. 2A to 2C, FIGS. 4A and 4B, and FIGS. 5A to 5C. To discriminate from the examples of already explained embodiments, 300 is added to the reference numerals.

As shown in FIG. 6A, the diffraction element 321 has a grating area (dividing pattern) 321-0 defined to have the same position and size as those of a 0^{th} light (non-diffracted light) of the reflected laser beam from the optical disc D, like the diffraction element shown in FIGS. 2A to 2C, FIGS. 4A and 4B, and FIGS. 5A to 5C.

The grating area (dividing pattern) 321-0 is divided into four areas, 321A-321D, by a first boundary line 321R passing through substantially the center of the radial direction and a second boundary line 321T (tangential direction) crossing at substantially the center of the boundary line 321R.

At the center of the 4-divided area, 2-divided areas 321E and 321F with grooves formed in the direction parallel to the boundary line 321R are formed by a division line 321X defined concentrically. Inside the circular area (division line 321X) defined by the 2-divided areas 321E and 321F, a seventh area 321G is defined by a concentric circle division line 321Y.

Each of the 4-divided areas has a curved surface pattern of grating grooves given curves with uneven intervals along the boundary line 321T extending direction, from the position where the boundary line 321R crosses the boundary line 321T. Each area 321A to 321D of the diffraction elements 321 has a curved surface pattern of grating grooves with uneven intervals to provide a lens effect having power, so that diffracted light is continuously changed in the direction and condensed when a parallel light is applied, for example.

Each of the grating areas 321A, 321B, 321C, 321D, 321E and 321F of the diffraction element 321 is a blazed diffraction element, for example. A laser beam passing through each area is separated mainly to non-diffracted light (0^{th} light) and +1^{st} diffracted light.

The grating area 321G of the diffraction element 321 is a blazed diffraction element, for example. A laser beam passing through each area is diffracted mostly to +1^{st} diffracted light.

As shown in FIG. 6B, the light-receiving plane of the photodetector (PD) 315 has 4-divided first to fourth detecting areas 315-1A to 315-1D divided corresponding to the boundary lines 321R and 321T of the diffraction element 21. The light-receiving plane also has a first detecting cell 315-1 formed to have the intersection of the boundary lines 321R and 321T at substantially the center, a second detecting cell 315-2 divided into tow areas of 315-2A and 315-2B, a third detecting cell 315-3 divided into two areas of 315-3A and 315-3B, and fourth to seventh cells 315-4 to 315-7 provided independently in the direction orthogonal to the direction of second and third detecting cells 315-2 and 315-3, and eighth to ninth detecting cells 315-8 and 315-9 to condense the light diffracted by the diffracting area 321G.

The fourth to seventh detecting cells 315-4 to 315-7 correspond to the optical beams divided (diffracted) by the fifth and sixth diffracting areas 321E and 321F divided as concentric circles of the diffraction element 321. The eighth to ninth detecting cells 315-8 and 315-9 correspond to the optical beams divided (diffracted) by the seventh diffracting area 321G defined innermost in the diffraction element 321.

FIG. 6B shows the positions of the diffracted light and non-diffracted light of the first laser beam with a wavelength of 405 nm on the light-receiving surface of the photodetector 315, in the on-focus state that the spot diameter of a first laser beam with a wavelength of 405 nm is minimum on the recording surface of an optical disc.

When the laser beam with a wavelength of 405 nm from the first leaser element is reflected on the recording surface of the optical disc D with respect to the diffraction element 321 and photodetector 315 given the above-mentioned detecting areas, a non-diffracted light (0^{th} light) of the reflected laser beam passing through the areas 321A to 321F of the diffraction element 321 is condensed as S0 (S321-0) at substantially the center of the first detecting cell 315-1 of the photodetector 315, in the state that the spot diameter of the first laser beam with a wavelength of 405 nm is minimum on the recording surface of an optical disc. The size of the optical spot S0 condensed in the first detecting cell 315-1 is a predetermined size in the on-focus state, as already explained.

The spot S321A of the light with a wavelength of 405 nm diffracted by the area 321A of the diffraction element 321 is condensed on the line dividing the two detecting areas 315-2A and 315-2B of the second detecting cell 315-2 of the photodetector 315, with a size of 1/m (m=integer) compared with the size of the optical spot S0 condensed in the first detecting cell 315-1. The size difference between the spots S0 and S321A is attained by placing the photodetector 315 at the position where the non-diffracted light becomes the spot S0 with a predetermined size in the on-focus state of the objective lens 13, and arranging the gratings of the diffraction element 321 as a curved surface pattern with uneven intervals, as already explained.

The spot S321C of the light with a wavelength of 405 nm diffracted by the area 321C of the diffraction element 321 is condensed on the line dividing the two detecting areas 315-3A and 315-3B of the third detecting cell 315-3 of the photodetector 315, with a size of 1/m (m=integer) compared with the size of the optical spot S0 condensed in the first detecting cell 315-1. The size difference between the spots S0 and S321C is attained by placing the photodetector 315 at the position where the non-diffracted light becomes the spot S0 with a predetermined size in the on-focus state of the objective lens 13, and arranging the gratings of the diffraction element 321 as a curved surface pattern with uneven intervals, as already explained.

The first to fourth areas 321A to 321D of the diffraction element 321 are defined so that the power of the areas 321A and 321C of the diffraction grating 321 becomes the same in symmetry about a point around the position where the boundary lines 321R and 321T cross each other, and the sizes of two spots S321A and S321C of diffracted light are of course substantially the same.

The light with a wavelength of 405 nm diffracted by the areas 321B and 321D of the diffraction element 321 is focused at a predetermined position having no detecting cell in the photodetector 315 (not used in this system).

Namely, in the system using the diffraction grating shown in FIG. 6A and PD shown in FIG. 6B, by using the spots S321A and S321C condensed on the line dividing detecting cells in the second and third detecting cells 315-2 and 315-3, an focus error signal (FES) is obtained by the following equation, like a known double knife edge method, assuming an output of each detecting cell to be I (cell No.).
FES=I(315-2A)−I(315-2B)−I(315-3A)+I(315-3B) (28)
(substantially the same as the equation (2))

The spots S321E and S321F of the light diffracted by the areas 321E and 321F of the diffraction element 321 are condensed in the detecting cells 315-4 and 315-5 close to the first detecting cell 315-1.

A tracking error signal is obtained by the following equation based on the compensation push-pull method, assuming an output of each detecting cell to be I (cell No.).
[I(315-1D)+I(315-1C)]−[I(315-1A)+I(315-1B)]+m[I(315-4)−I(315-5)] m is a magnification (29)

The spot S321G of the light diffracted by the diffracting area 321G is condensed in the eight detecting cell 315-8 close to the first detecting cell 315-1.

In the system using the diffraction grating shown in FIG. 6A and PD shown in FIG. 6C, the positions of the diffracted light and non-diffracted light of the second laser beam with a wavelength of 650 nm on the light-receiving surface of the photodetector 315 are shown in the on-focus state that the spot diameter of a second laser beam with a wavelength of 650 nm is minimum on the recording surface of an optical disc.

When the laser beam with a wavelength of 650 nm from the second leaser element is reflected on the recording surface of the optical disc D, a non-diffracted light (0^{th} light) of the reflected laser beam passing through the areas 321A to 321F of the diffraction element 321 is condensed as S0 (S321-0) at substantially the center of the first detecting cell 315-1 of the photodetector 315, in the state that the spot diameter of a second laser beam with a wavelength of 650 nm is minimum on the recording surface of an optical disc, as shown in FIG. 6B.

The light with a wavelength of 650 nm diffracted by the areas 321B and 321D of the diffraction element 321 is condensed on the line dividing the two detecting areas 315-2A and 315-2B of the second detecting cell 315-3 of the photodetector 315, and on the line dividing the two detecting areas 315-3A and 315-3B of the third detecting cell 315-3, respectively, as shown in FIG. 6C.

The light diffracted by the areas 321A and 321C of the diffraction element 221 is condensed at a predetermined position having no detecting cell in the photodetector 315 (not used in this system).

The spot S321G of the light diffracted by the diffracting area 321G is condensed in the ninth detecting cell 315-9 far from the first detecting cell 315-1.

Namely, a focus error can be detected by using the spots condensed on the division lines in the second and third detecting cells 315-2 and 315-3, respectively, regardless of the wavelength of a laser beam. The S/N can be increased by controlling the light amount of 1^{st} diffraction light by setting the light amount ratio of 1^{st} diffraction light to 0^{th} diffraction light small.

The spots S321E and S321F of the light with a wavelength of 650 nm diffracted by the areas 321E and 321F of the diffraction element 221 are condensed in the detecting cells 315-6 and 315-7 far from the first detecting cell 315-1.

A tracking error signal is obtained by the following equation based on the compensation push-pull method, assuming an output of each detecting cell to be I (cell No.).
[I(315-1D)+I(315-1C)]−[I(315-1A)+I(315-1B)]+n[I(315-6)−I(315-7) m is a magnification (29′)

Of course, it is possible to detect the tracking error signal (TES) regardless of the wavelength of laser beam, by using a phase difference by time based on the DPD (Differential Phase Detection) method, as follows.

TES=Phase difference between

[I(a′)] and [I(b′)]
I(a′)=(315-1A)+I(315-1C);
I(b′)=(315-1B)+I(315-1D); (30)

The reproducing signal S can be output with the S/N improved by the following equation, based on substantially the same idea as the example shown in FIGS. 2A to 2C, by adding the output of the spots S321G detected by the eight or ninth detecting cell having comparatively less noise component.
S=I(315-1D)+I(315-1C)+I(315-1A)+I(315-1B)+I(315-8) (31)
or
S=I(315-1D)+I(315-1C)+I(315-1A)+I(315-1B)+I(315-9) (31′)

Though not explained in detail, by decreasing the number of detecting cells to add a signal to a least minimum, and adding the output (close to the center of an optical spot) difficult to be influenced by a noise component, the number of addition circuits can be decreased, the cost of PUH (optical pickup) can be decreased, and a reproducing signal with high S/N can be obtained.

As above explained, when dividing the reflected light from an optical disc by using a diffraction element and obtaining a focus error signal by the double knife edge method, the detecting (light-receiving) cells of a photodetector for obtaining a focus error signal can be shared in an optical pickup unit using two or more leaser beams with different wavelengths, according to standards/kinds of an optical disc. This decreases the number/area of detecting cells of a photodetector, and provides a pickup head (PUH) with high S/N (signal/noise) and low-cost.

By arranging gratings of a diffraction element as a curved surface pattern with uneven intervals, the focal positions of diffracted light and non-diffracted light of a reflected light from an optical disc can be displaced by a predetermined amount in the axial direction, and the influence of a lens shift component included in a tracking error signal can be eliminated.

Further, a compensation push-pull signal used for compensation of a tracking error signal can be easily obtained, and a signal processing system can be made simple.

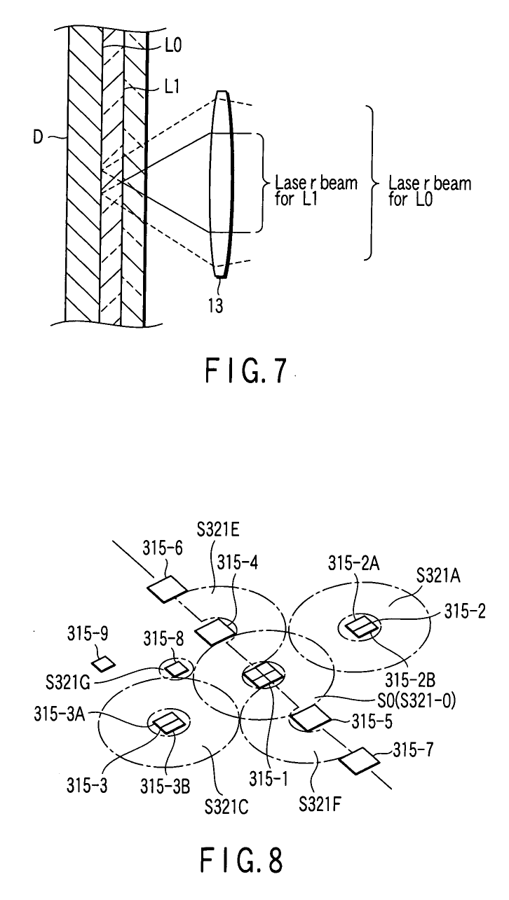

FIG. 7 shows the characteristic of an optical beam (laser beam) applied to the objective lens 13, when the optical disc D has two recording layers.

As shown in FIG. 7, when the optical disc D has a first recording layer L0 and a second recording layer L1, a signal from the layer not to reproducing the signal may also be reflected, causing a noise such as a focus error signal and a tracking error signal.

For example, when reproducing the signal of the Layer L1 by applying a laser beam with a wavelength of 405 nm to the recording layer of the optical disc D, even if the laser beam is condensed on the layer L1, a part of the light passes through the layer L1 and reflects on the layer L0.

The signal having the information of the layer L0 may be included in a focus error signal or a tracking error signal.

Therefore, by arranging the central area of the diffraction element explained in FIG. 6A having an independent diffracting area at the center as a suitable diffraction pattern, the area around the detecting cell to receive a reflected laser beam is given a detection characteristic just like substantially masked, when the reflected light from the layer L0 is diffracted (separated) on the light-receiving plane of the photodetector shown in FIG. 6B.

More specifically, when a laser beam with a wavelength of 405 nm is condensed on the layer L1 of the optical disc D, the optical images S0 (S321-0) and S321A to G of the light reflected by the layer L0 in the light-receiving element 15 become to be as shown in FIG. 8. Namely, since a laser beam is not condensed on the layer L0, the optical image of the reflected light from the layer L0 on the light-receiving element 15 is larger than the optical image from the layer L1 shown in FIG. 6B.

Further, since most of the spot S321G of the light passing through the central part 321G of the diffraction grating 321 among the reflected light from the optical disc D is diffracted in the +1^{st} direction, and condensed at the position around the light-receiving cell 315-8 not overlapping with the light-receiving cells 315-1 to 315-7 which generate signals to obtain focus error and tracking error signals, the optical images S321A to S321F of the non-diffracted light and diffracted light 321A to 321F of the reflected light from the layer L0 lack a central part corresponding to the central part 321G of the diffraction grating 321.

Therefore, the non-diffracted light S0 (S321-0) of the reflected light from the layer L0 and the spots S321A to S321F of the diffracted light diffracted by the areas S321A to 321F of the diffraction grating 321 are not applied to the light-receiving cells 315 to 317 of the light-receiving element 315 which generates a signal to obtain a focus error signal or a tracking error signal.

The signal having the information of the layer L0 is not included in a focus error signal or a tracking error signal. Of course, the same processing is possible in the state the focuses of the layers L0 and L1 are reversed.

Therefore, stable focus control and tracking are possible for an optional recording layer of an optical disc having two or more recording layers.

The reproducing signal S can be obtained by
S=I(315-1)+I(315-2)+I(315-3)+I(315-4)+I(315-5)+I(315-6)+I(315-7) (32)

For an optical disc with little leakage of signal from the layer other than the recording layer to reproducing, the reproducing signal S can also be obtained by the following equation, by using the outputs of all detecting cells of the photodetector shown in FIG. 6C, to increase the signal amplitude.
S=I(315-1)+I(315-2)+I(315-3)+I(315-4)+I(315-5)+I(315-6)+I(315-7)+I(315-8)+I(315-9) (33)

As explained hereinbefore, in the optical pickup unit as one of the embodiments of the invention and information recording/reproducing apparatus (using the optical pickup unit), a focus error signal can be exactly detected from the reflected light of laser beams with two or more wavelengths based on the types of recording media.

Therefore, the focusing accuracy of the optical pickup is increased regardless of the standards and types of recording media, and correct focus control and stable signal reproducing are possible.

When dividing the reflected light from an optical disc by using a diffraction grating given suitable area and suitable number of dividing (groove) patterns, and obtaining a focus error signal by a double knife edge method, for example, the detecting (light-receiving) cells of a photodetector for obtaining a focus error signal can be shared in an optical pickup unit using two or more leaser beams with different wavelengths, according to standards/kinds of an optical disc. This decreases the number/area of detecting cells of a photodetector, and provides a pickup head (PUH) with high S/N (signal/noise) and low-cost.

By arranging gratings of a diffraction element as a curved surface pattern with uneven intervals, the focal positions of diffracted light and non-diffracted light of a reflected light from an optical disc can be displaced by a predetermined amount in the axial direction, and the influence of a lens shift component included in a tracking error signal can be eliminated.

Further, a compensation push-pull signal used for compensation of a tracking error signal can be easily obtained, and a signal processing system can be made simple.

In the embodiments explained above, the dividing pattern of a luminous flux of a reflected laser beam from a diffraction element and the corresponding arrangement of detecting cells of a photodetector are just an example. The dividing pattern and arrangement of detecting cells are not limited to them, as long as diffracted light and non-diffracted (0^{th}) light of a reflected laser beam can be obtained.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

For example, in the detailed description of the invention, an information recording/reproducing apparatus is taken as an example of embodiment of the invention. The invention is of course applicable also to a video camera and a portable acoustic apparatus to contain musical data.

What is claimed is:

1. An optical pickup unit comprising:
light sources which output light with different wavelengths;
a condensing means which condenses light emitted from the light sources on the recording surface of a recording medium;
a dividing means which divides the light reflected by the recording medium; and
a light-detecting means which detects the reflected light divided by the dividing means,
wherein the dividing means has light-dividing areas, and the light-dividing areas are provided at least two pairs symmetrical to the radial direction of the recording surface of the recording medium.

2. The optical pickup unit according to claim 1, wherein the dividing means focuses at least some of light beams of different wavelengths at the same position.

3. The optical pickup unit according to claim 2, wherein the same position on the light-detecting means generates a signal usable to control the relative position between the position to condense the light from the light sources by the condensing means and the recording surface of the recording medium.

4. The optical pickup unit according to claim 1, wherein the light-dividing areas of the dividing means have a predetermined power.

5. The optical pickup unit according to claim 1, wherein the dividing means includes a hologram diffraction grating.

6. The optical pickup unit according to claim 5, wherein the dividing means condenses a non-diffracted light at a different position from a diffracted light.

7. The optical pickup unit according to claim 1, further comprising a diffraction grating which is configured to set the ratio of the total light amount of non-diffracted light and diffracted light applied to the light-receiving cells in the light-receiving element, to the light amount of the reflected light applied to the diffraction grating, high for light with a short wavelength.

8. The optical pickup unit according to claim 1, wherein the wavelength of the light emitted from the light sources preferably includes one of 400 to 410 nm and 650 to 660 nm (640 to 670 nm), or 400 to 410 nm and 770 to 790 nm.

9. The optical pickup unit according to claim 1, wherein the light-detecting means includes an optional number of light-receiving cells configured to detect the reflected light divided by the dividing means, and the light-receiving cells to detect the diffracted light of the light passing through the dividing means are independently provided corresponding to the wavelengths of the light emitted from the light sources.

10. An optical pickup unit comprising:
a first laser element which outputs light with a first wavelength;
a second laser element which emits light with a second wavelength different from the light from the first laser element;
a lens which condenses the light from the first and second laser elements on the recording surface of an optical disc, and captures a reflected light reflected on the recording surface of the optical disc;
a diffraction element which has areas, includes at least a part of the areas including a diffraction pattern symmetrical to the radial direction of the optical disc, divides the reflected light captured by the lens into a non-diffracted light and an optional number of diffracted light, guides the optional number of light of the divided diffracted light in a predetermined direction, and gives the guided diffracted light a predetermined convergence corresponding to the wavelength; and
a photodetector which has light-detecting cells, and detect each of the reflected light divided by the diffraction element.

11. An information recording/reproducing apparatus comprising:
an optical pickup unit comprising light sources which output light with different wavelengths;
a condensing means which condenses light emitted from the light sources on the recording surface of a recording medium; a dividing means which divides the light reflected by the recording medium; and a light-detecting means which detects the reflected light divided by the dividing means, wherein the dividing means has light-dividing areas, and the light-dividing areas are provided at least two pairs symmetrical to the radial direction of the recording surface of the recording medium;
an output signal processor which takes out information recorded in the recording medium from the reflected light from the recording medium detected by the light-detecting means; and
a controller which controls the position of the condensing means of the optical pickup unit.
